(19) United States
(12) Patent Application Publication
(10) Pub. No.: US 2008/0040407 A1
(43) Pub. Date: Feb. 14, 2008

(54) IDENTIFICATION OF A CAUSE OF AN ALLOCATION FAILURE IN A JAVA VIRTUAL MACHINE

(75) Inventors: Li Ge, Austin, TX (US); Hui Jiang, Austin, TX (US); Yu Tang, Round Rock, TX (US); Ping Wang, Austin, TX (US)

Correspondence Address: CANTOR COLBURN LLP - IBM AUSTIN, 55 GRIFFIN ROAD SOUTH, BLOOMFIELD, CT, 06002, US

(73) Assignee: International Business Machines Corporation, Armonk, NY (US)

(21) Appl. No.: 11/463,767

(22) Filed: Aug. 10, 2006

(51) Int. Cl. G06F 17/30

(52) U.S. Cl. 707/206

(57) ABSTRACT

A method of identifying a cause of an allocation failure in a Java virtual machine is presented. The method includes getting a stack trace of a thread that triggers an allocation failure. In response to the allocation failure that meets specified criteria, including the stack trace in the Verbose garbage collector output resulting from the garbage collection cycle. The method further includes identifying a cause of the allocation failure from the Verbose garbage collector output that includes the stack trace and taking corrective action to avoid repeating the allocation failure.

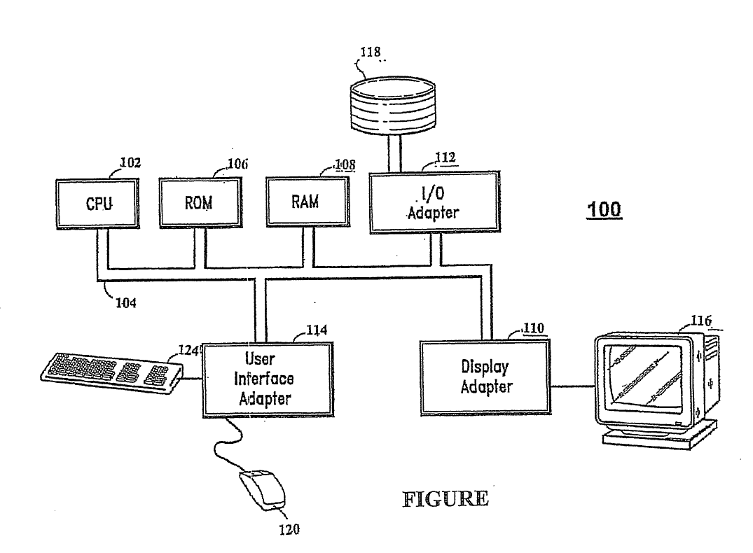

### BACKGROUND OF THE INVENTION

1. Field of the Invention

This invention relates to digital data processing, and particularly to identification of a cause of an allocation failure in a Java virtual machine.

2. Description of Background

A runtime system is a code execution environment that executes instructions or code in user requests and that provides runtime services for that code. Core runtime services can include functionality such as process, thread, and memory management (e.g., laying out objects in the server memory, sharing objects, managing references to objects, and garbage collector objects). A garbage collector (GC) object periodically frees all the objects that are no longer needed or can no longer be “reached” by the running program. Ideally, garbage collection will clean up all objects that are no longer needed by the program.

One example of a runtime system is a virtual machine (VM). A VM is an abstract machine that can include an instruction set, a set of registers, a stack, a heap, and a method area, like a real machine or processor. A VM essentially acts as an interface between program code and the actual processor or hardware platform on which the program code is to be executed. The program code includes instructions from the VM instruction set that manipulates the resources of the VM. The VM executes instructions on the processor or hardware platform on which the VM is running, and manipulates the resources of that processor or hardware platform, so as to effect the instructions of the program code. In this way, the same program code can be executed on multiple processors or hardware platforms without having to be rewritten or recompiled for each processor or hardware platform. Instead, a VM is implemented for each processor or hardware platform, and the same program code can be executed in each VM. The implementation of a VM can be in code that is recognized by the processor or hardware platform.

The Java programming language is designed to be implemented on a Java VM (JVM). A Java source program is compiled into program code known as bytecode. Bytecode can be executed on a JVM running on any processor or platform. The JVM can either interpret the bytecode one instruction at a time, or the bytecode can be further compiled for the real processor or platform using a just-in-time (JIT) compiler.

During each garbage collection cycle a Verbose GC output is generated, which provides information about what has occurred. This information can be used to tune heap size (heap expansion or heap shrinkage) or diagnose a problem. The Verbose GC output may indicate an allocation failure collection. An allocation failure does not mean there has been an error in the code; it's the name of the event that is triggered when JVM cannot allocate a large enough portion of a heap to satisfy the request of the application, most likely because the heap is occupied by objects that are no longer reachable and need to be garbage collected. The size of the request space is included in the verbose GC output. Possible allocation failure actions include garbage collection. Although allocation failure does not mean an error condition, it can be indicative of potential problems in the application. For example, normally an application does not need to allocate very large objects, if there is an allocation failure for a large object, it is indicative of potential problem with the application.

In a Verbose GC output for a compaction there is an additional line showing how many objects have been moved, how many bytes have been moved, the reason for the compaction, and how many additional bytes have been added. It is possible to have additional bytes, because if an object is moved that has been hashed then the JVM has to store the hash value in the object, which may mean increasing the object's size.

Other Verbose GC outputs include outputs for a concurrent mark kick-off, a concurrent mark system collection, a concurrent mark allocation failure collection, a concurrent mark collection, and a resettable.

While analyzing the Verbose GC output typically provides enough information to identify what the problem is, it does not provide enough information to identify the source or root of a problem.

### SUMMARY OF THE INVENTION

The shortcomings of the prior art are overcome and additional advantages are provided through the provision of a method of identifying a cause of an allocation failure in a Java virtual machine when the allocation failure indicates potential problem with the application. The method includes getting a stack trace of a thread that triggers the allocation failure. In response to the allocation failure that meets specified criteria, initiating a garbage collection cycle to generate a Verbose garbage collector output resulting from the garbage collection cycle. The specified criteria includes, e.g., the size of the allocation failure is larger than one megabyte. The Verbose garbage collector output includes the stack trace. The method further includes identifying a cause of the allocation failure from the Verbose garbage collector output that includes the stack trace.

System and computer program products corresponding to the above-summarized methods are also described and claimed herein.

As a result of the summarized invention, technically we have achieved a solution which through analyzing the Verbose GC output provides not only enough information to identify what the problem is, but also enough information to identify the source or root of a problem. Once the source or root of the problem is identified corrective action can be taken.

### BRIEF DESCRIPTION OF THE DRAWING

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawing in which the FIGURE diagrammatically illustrates one example of a general-purpose computer system to which the present invention may be applied.

The detailed description explains the preferred embodiments of the invention, together with advantages and features, by way of example with reference to the drawing.

### DETAILED DESCRIPTION OF THE INVENTION

Turning now to the drawings in greater detail, it will be seen that in the FIGURE there is a general-purpose computer system 100 to which the present invention may be applied. The computer system 100 includes at least one processor (CPU) 102 operatively coupled to other components via a system bus 104. A read only memory (ROM) 106, a random access memory (RAM) 108, a display adapter 110, an I/O adapter 112, and a user interface adapter 114 are coupled to system bus 104. Display adapter 110 operatively couples a display device 116 to system bus 104. A disk storage device (e.g., a magnetic or optical disk storage device) 118 is operatively coupled to system bus 104 by I/O adapter 112. User interface adapter 114 operatively couples a mouse 120 and keyboard 124 to system bus 104. One or more objects (not shown) are created when an Object-Oriented Program (not shown) is executed in computer system 100. In a preferred embodiment, computer system 100 executes Java software objects.

A Java virtual machine (JVM) is an abstract machine that is configured to implement the Java programming language. The JVM includes an instruction set, a set of registers, a stack, a heap, and a method area. A Java source program is compiled into program code known as bytecode, which are executed on a JVM running on the processor 102. The JVM can either interpret the bytecode one instruction at a time, or the bytecode can be further compiled for the processor 102 using a just-in-time (JIT) compiler. Runtime services include functionality such as process, thread, and memory management (e.g., laying out objects in the server memory, sharing objects, managing references to objects, and garbage collector objects). A garbage collector (GC) object periodically frees all the objects that are no longer needed or can no longer be “reached” by the running program. Ideally, garbage collection will clean up all objects that are no longer needed by the program.

During each such garbage collection cycle a Verbose GC output is generated, which provides information about what has occurred. The Verbose GC output typically indicates an allocation failure collection. An allocation failure is an event that is triggered when JVM cannot allocate a large enough portion of the heap to satisfy the request of the application, most likely because the heap is occupied by objects that are no longer reachable and need to be garbage collected. The size of the request space is included in the verbose GC output. Possible allocation failure actions include garbage collection. Other Verbose GC outputs are known, and have been discussed above.

In lower-level programming languages there is a functionality known as a “stack trace”, which is a debugging functionality that is used by programmers to track down bugs that appear in code. The stack trace allows a programmer to pull up the list of functions that were called which lead to some crash or exception in the code.

In the present example, when a thread triggers an allocation failure that meets a specified criteria, the JVM gets a stack trace of the thread. The specified criteria includes an allocation failure of one megabyte or larger. However, other criteria may be specified as dictated by a particular application. In a subsequent garbage collection cycle, a Verbose GC output is generated by the JVM, which includes the stack trace. The Verbose GC output including the stack trace is printed or otherwise displayed.

As discussed above, an allocation failure is an event that is triggered when JVM cannot allocate a large enough portion of the heap. More specifically, a thread tries to allocate memory space for an object but not enough space is left on the heap. In many cases, an allocation of a large object or a repeated allocation of a fixed size object is caused by an application error. It is normally a tedious and time-consuming process to identify the root cause of a memory allocation problem, especially in a production environment. The stack trace in the verbose GC output would point directly to the code path that caused a problem. The overhead of including the stack trace with the Verbose GC output is minimal.

An Example 1 below is a Verbose GC output where there are repeated allocations of an object of the same size:

### EXAMPLE 1

<AF[38]: Allocation Failure. need 2064 bytes, 980 ms since last AF>
<AF[38]: managing allocation failure, action=2 (378904/
536803840)><GC(38): GC cycle started Tue Jun 1 14:31:24 2004
<GC(38): freed 499108448 bytes, 93%% free (499487352/536803840),
in 733 ms>
<GC(38): mark: 214 ms, sweep: 37 ms, compact: 482 ms>
<GC(38): refs: soft 0 (age >= 32), weak 0, final 0, phantom 0>
<GC(38): moved 7274 objects, 417016 bytes, reason=9>
<AF[38]: completed in 733 ms>
<AF[39]: Allocation Failure. need 2064 bytes, 1311 ms since last AF>
<AF[39]: managing allocation failure, action=2 (377096/536803840)>
<GC(39): GC cycle started Tue Jun 1 14:31:26 2004
<GC(39): freed 499110216 bytes, 93%% free (499487312/536803840),
in 614 ms>
<GC(39): mark: 214 ms, sweep: 63 ms, compact: 337 ms>
<GC(39): refs: soft 0 (age >= 32), weak 0, final 0, phantom 0>
<GC(39): moved 6457 objects, 378928 bytes, reason=9>
<AF[39]: completed in 614 ms>
<AF[40]: Allocation Failure. need 2064 bytes, 747 ms since last AF>
<AF[40]: managing allocation failure, action=2 (376320/536803840)>
<GC(40): GC cycle started Tue Jun 1 14:31:27 2004
<GC(40): freed 499137408 bytes, 93%% free (499513728/536803840),
in 911 ms>
<GC(40): mark: 473 ms, sweep: 75 ms, compact: 363 ms>
<GC(40): refs: soft 4 (age >= 32), weak 0, final 4, phantom 0>
<GC(40): moved 9716 objects, 648808 bytes, reason=9>
<AF[40]: completed in 912 ms>

From Example 1 it can be seen that the JVM is spending most of the time doing garbage collection that is triggered by the allocation of what would appear to be the same type of object. This means that the application is allocating and freeing the same type of objects in a very rapid fashion. When this happens, the application performance degrades because the time is spent on the garbage collection. However, there is not enough information from the above Verbose GC output to know which part of the application is allocating the objects.

An Example 2 below is the same Verbose GC output as Example 1 above, but includes a stack trace:

### EXAMPLE 2

<AF[40]: Allocation Failure, need 2064 bytes, 747 ms since last AF>
<AF[40]: managing allocation failure, action=2 (376320/536803840)>
<GC(40): GC cycle started Tue Jun 1 14:31:27 2004
<GC(40): freed 499137408 bytes, 93%% free (499513728/536803840),
in 911 ms>
<GC(40): mark: 473 ms, sweep: 75 ms, compact: 363 ms>
<GC(40): refs: soft 4 (age >= 32), weak 0, final 4, phantom 0>
<GC(40): moved 9716 objects, 648808 bytes, reason=9>
<AF[40]: completed in 912 ms>
<stacktrace>
3d8a57c0 7cc93440 00001dbc localMark
/u/sovbld/cm131s/cm131s-20031114/src/jvm/sov/st/msc/gc_mark.c
3d8a56c8 7ccad570 0000026a parallelMark
/u/sovbld/cm131s/cm131s-20031114/src/jvm/sov/st/msc/gc_mark.c
3d8a5580 7ccc3678 0000160c gc0_locked
/u/sovbld/cm131s/cm131s-20031114/src/jvm/sov/st/msc/gc_mwmain.c
3d8a5480 7ccb5070 000000c0 gc_locked
/u/sovbld/cm131s/cm131s-20031114/src/jvm/pfm/st/msc/gc_md.c
3d8a5358 7ccca7f0 0000082c gc0
/u/sovbld/cm131s/cm131s-20031114/src/jvm/sov/st/msc/gc_mwmain.c
3d8a5240 7cccc160 00000d98 manageAllocFailure
/u/sovbld/cm131s/cm131s-20031114/src/jvm/sov/st/msc/gc_mwmain.c
3d8a5150 7cc288a8 0000080a lockedHeapAlloc
/u/sovbld/cm131s/cm131s-20031114/src/jvm/sov/st/msc/gc_alloc.c
3d8a5060 7cc31c48 00000916 allocMiddlewareContextArray
/u/sovbld/cm131s/cm131s-20031114/src/jvm/sov/st/msc/gc_alloc.c
3d8a4fa8 076490b8 000000c2 @@GETFN
3d8a4e80 7cd2aed8 0000c3d4 mmipSelectInvokeJavaMethod
com/sun/jndi/ldap/Connection.run
3d8a4da8 7cd2aed8 00000534 mmipSelectInvokeJavaMethod java/lang/
Thread.run
</stacktrace>

From the Verbose GC output of Example 2, the root cause of the problem is easily found. The stack trace points directly to the com.sun.jndi.ldap.Connection.run( ) method. In contrast, without the stack trace generated with the Verbose GC output, a programmer would have to resort to the Java core dump, which is taken separately with the hope of figuring out which thread caused the allocation failure and subsequent garbage collection. However, this thread dump approach requires additional steps and often does not work because of timing issues

An Example 3 below is a Verbose GC output where there are allocations of some large objects:

### EXAMPLE 3

<AF[69]: Allocation Failure. need 1753096 bytes, 54886 ms since
last AF>
<AF[69]: managing allocation failure, action=2 (301115440/
1073674752)>
<GC(77): GC cycle started Mon Jul 19 10:46:16 2004
<GC(77): freed 628265120 bytes, 86%% free (929380560/1073674752),
in 9579 ms>
<GC(77): mark: 9034 ms, sweep: 545 ms, compact: 0 ms>
<GC(77): refs: soft 0 (age >= 32), weak 12, final 1574, phantom 2>
<AF[69]: completed in 9579 ms>
<AF[70]: Allocation Failure. need 2129176 bytes, 124 ms since last AF>
<AF[70]: managing allocation failure, action=2 (925609328/
1073674752)>
<GC(78): GC cycle started Mon Jul 19 10:46:30 2004
<GC(78): freed 8434392 bytes, 86%% free (934043720/1073674752),
in 14032 ms>
<GC(78): mark: 5346 ms, sweep: 1099 ms, compact: 7587 ms>
<GC(78): refs: soft 0 (age >= 32), weak 0, final 10, phantom 0>
<GC(78): moved 1515366 objects, 91566576 bytes, reason=1, used 128
more bytes>
<AF[70]: completed in 14034 ms>

As is shown in the Verbose GC output of Example 3, allocations of Java objects of more than 1 MB indicates some problems in the application code and it is not trivial work to identify the actual code that create a large objects.

An Example 4 below is the same Verbose GC output as Example 3 above, but includes a stack trace:

### EXAMPLE 4

<AF[70]: Allocation Failure. need 2129176 bytes, 124 ms since last AF>
<AF[70]: managing allocation failure, action=2 (925609328/1073674752)>
<GC(78): GC cycle started Mon Jul 19 10:46:30 2004
<GC(78): freed 8434392 bytes, 86%% free (934043720/1073674752), in 14032 ms>
<GC(78): mark: 5346 ms, sweep: 1099 ms, compact: 7587 ms>
<GC(78): refs: soft 0 (age >= 32), weak 0, final 10, phantom 0>
<GC(78): moved 1515366 objects, 91566576 bytes, reason=1, used 128 more bytes>
<AF[70]: completed in 14034 ms>
<stacktrace>
1d04cf60 7cc33080 e1a5eeb2 allocMiddlewareArray
/u/sovbld/cm131s/cm131s-20031114/src/jvm/sov/st/msc/gc_alloc .c
1d04cdf8 5e9a335c 000002a0
com/wpsic/utilities/cicsbroker/visitors/AnnotatedDumpVisitor.visit(Lcom/wpsic/utilities/
cicsbroker/schema/CICSLeaf;)V
com/wpsic/utilities/cicsbroker/visitors/AnnotatedDumpVisitor.java
1d04cd30 5e922b24 000000a6
com/wpsic/utilities/cicsbroker/schema/CICSLeaf.accept(Lcom/wpsic/utilities/cicsbroker/
visitors/SchemaVisitor;)V
com/wpsic/utilities/cicsbroker/schema/CICSLeaf.java
1d04cc40 5e9a2568 0000029c
com/wpsic/utilities/cicsbroker/parser/ResponseTreeWalker.walk(Lcom/wpsic/utilities/
cicsbroker/schema/CICSStruct;Ljava/lang/String;Lcom/w
psic/utilities/cicsbroker/visitors/ResponseVisitor;)V
com/wpsic/utilities/cicsbroker/parser/ResponseTreeWalker.java
1d04ca90 61350d24 00000d40
com/wpsic/utilities/cicsbroker/cache/CICSBindingCache.getBinding(Lcom/wpsic/
utilities/cicsbroker/request/CICSRequest;)Lcom/wpsic/utilities
/cicsbroker/schema/CICSBinding;
</stacktrace>

From the Verbose GC output of Example 4, it is very easy to see from the stack trace that AnnotatedDumpVisitor.visit( ) method causes the allocation of the large object in this case. Again, without the stack trace, a programmer would not likely find the offending thread.

Once the source (cause) of the failure has been identified, appropriate corrective action can be taken, so as to avoid repeating the failure.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of identifying a cause of an allocation failure in a Java virtual machine, comprising:
getting a stack trace of a thread that triggers an allocation failure and thereby a subsequent garbage collection cycle;
in response to the allocation failure that meets a specified criteria, including the stack trace in a Verbose garbage collector output resulting from the garbage collection cycle; and
identifying a cause of the allocation failure from the Verbose garbage collector output that includes the stack trace.

2. The method of claim 1 further comprising taking corrective action to avoid repeating the allocation failure.

3. The method of claim 1 wherein the specified criteria comprises the allocation failure of at least one megabyte.

4. The method of claim 1 further comprising displaying the Verbose garbage collector output that includes the stack trace.

5. The method of claim 1 further comprising printing the Verbose garbage collector output that includes the stack trace.

6. A storage medium encoded with machine-readable computer program code for identifying a cause of an allocation failure in a Java virtual machine, the storage medium including instructions for causing a computer to implement a method comprising:
getting a stack trace of a thread that triggers an allocation failure and thereby a subsequent garbage collection cycle; and
in response to the allocation failure that meets a specified criteria, including the stack trace in a Verbose garbage collector output resulting from the garbage collection cycle.

7. The storage medium of claim 6 wherein the method further comprises the specified criteria comprising the allocation failure of at least one megabyte.
